(19) United States
(12) Patent Application Publication
(10) Pub. No.: US 2014/0037160 A1
(43) Pub. Date: Feb. 6, 2014

(54) Image Processing Apparatus

(71) Applicant: Hitachi, Ltd., Tokyo (JP)

(72) Inventors: Kazuki MATSUZAKI, Tokyo (JP); Shinji TARUMI, Tokyo (JP); Shuntaro YUI, Tokyo (JP)

(73) Assignee: Hitachi, Ltd., Tokyo (JP)

(21) Appl. No.: 13/953,359

(22) Filed: Jul. 29, 2013

(30) Foreign Application Priority Data
Aug. 2, 2012 (JP) 2012-172379

(51) Int. Cl. G06T 7/00

(52) U.S. Cl. CPC G06T 7/0012
USPC 382/128

(57) ABSTRACT

An image processing apparatus includes a process flow building unit, a process flow execution unit, a display unit, a selection unit, a process flow evaluation unit, and a storage unit including a process flow database. In addition, an image processing apparatus includes an image processing parameter adjusting unit, a process flow execution unit, a display unit, a selection unit, a parameter evaluation unit, and a storage unit including a parameter database.

### BACKGROUND OF THE INVENTION

1. Field of the Invention

The present invention relates to an image processing apparatus and in particular, to an image processing apparatus including an evaluation unit of image processing flows and image processing parameters.

2. Background Art

In recent years, medical image diagnosis has been widely performed since information regarding the inside of the body can be acquired non-invasively. Three-dimensional images obtained by various types of diagnostic imaging apparatuses, such as an X-ray computer tomography (CT) apparatus, a magnetic resonance imaging (MRI) apparatus, a positron emission tomography (PET) apparatus, and a single photon emission computed tomography (SPECT) apparatus, are used for the diagnosis or for follow-up examination.

On the other hand, images obtained by the medical image diagnostic apparatuses described above are viewed just for reading, and it is also possible to obtain a variety of information by performing image processing on the images. For example, in the X-ray CT apparatus, it is possible to obtain a volume image with high spatial resolution. Therefore, it is possible to extract an organ, blood vessels, and the like using a segmentation technique and visualize them in a three-dimensional manner using a volume rendering method. In addition, it is possible to extract a lesion, such as a tumor, using various image processing algorithms and evaluate the lesion quantitatively by calculating its maximum diameter, volume, or the like as well as simply visualizing it.

As a system for supporting medical image diagnosis in the related art, a computer aided diagnosis (CAD) system has been proposed. When the CAD is finely classified according to the function, it is divided into Computer Aided Detection (CADe) and Computer Aided Diagnosis (CADx). The CADe has a function of automatically detecting a candidate location, at which a lesion is present, on an image using a computer and marking the location, and supports pinpointing the lesion.

On the other hand, the CADx has not only the function of the CADe but also a function of outputting the numerical values of the physical characteristics (maximum diameter, volume, and the like) of the candidate lesion or the data or numerical value of the degree of progress of the lesion or benignness/malignancy determination, and supports diagnosis by outputting the qualitative and quantitative data of the lesion itself. Among these, CADe systems for lung cancer and breast cancer are already commercially available, and the importance is increasing.

Thus, medical image diagnostic apparatuses or images obtained from the apparatuses are wide-ranging, and the method of processing the images is also wide-ranging. Therefore, it is important to select and execute an image, an image processing method, and its flow suitable for the purpose.

JP-T-2007-528746 discloses a computer aided decision (CAD) support system that uses machine learning classification in order to automatically detect a problem portion in a medical image and mark it.

As described above, images acquired by medical image apparatuses are wide-ranging depending on the purpose. In addition, for the images acquired by the medical image apparatuses, various kinds of image processing applications are proposed depending on the purpose of image processing. As the image processing application, it is typical to execute the process flow using a single or a plurality of image processing algorithms. Thus, types of image processing applications are also wide-ranging. When executing these in combination, the number of combinations of images and image processing flows to be processed is very large. For this reason, it will be increasingly difficult for the operator to select an optimal process flow for his or her intention from a number of these combinations of image processing flows.

In the system disclosed in JP-T-2007-528746, there is provided a computer aided decision (CAD) support system that uses machine learning classification in order to automatically detect a problem portion in a medical image and mark it. This system includes machine learning means for performing adaptation and optimization of the CAD process. The machine learning means performs adaptation and optimization of the CAD process by constantly inputting the knowledge of a doctor to the CAD process using the training data obtained from the daily use of the CAD support system.

Specifically, in the CAD system disclosed in JP-T-2007-528746 that detects, diagnoses, and marks a problem portion in a medical image, a detected problem portion is displayed together with a CAD mark indicating the detected problem portion, so that the user recognizes it as a problem portion. In addition, an approach to obtain training data by linking the CAD mark with the input user mark is taken. In the above-described method, the system and the user mark the lesion location on the image, and training data for learning is created by cooperation of the marks. Accordingly, it is possible to learn the location of a lesion or the like as a function of the CADe, but it is difficult to learn the three-dimensional quantitative characteristic values of the lesion as a function of the CADx. In addition, in the CAD system disclosed in JP-T-2007-528746, a function of learning various kinds of image processing, image processing flows obtained by combining the various kinds of image processing, parameters required for image processing cannot be provided.

The main reason why it is difficult for the operator to select and execute image processing according to his or her intention or an image processing flow based on the combination is that combinations of process flows, which are to be executed by the operator or have been executed by the operator, are not present. In addition, since each parameter for image processing that configures the image processing flow changes depending on the purpose, an optimal parameter is not clear according to the purpose. For this reason, in the related art, selection of an image processing flow or adjustment of parameters depending on the experience or the like of the operator has been performed.

### SUMMARY OF THE INVENTION

It is an object of the invention to provide a technique capable of easily evaluating the processing result of the image processing flow (combination of image processing algorithms or parameters) executed by the operator and presenting an optimal image processing flow according to the intention of the operator by accumulating and learning the evaluation result.

In order to solve the above-described problem, according to an aspect of the invention, there is provided an image processing apparatus including: a process flow building unit that builds a plurality of image processing flows on the basis of a combination of a plurality of image processing algorithms; a process flow execution unit that executes the plurality of image processing flows built by the process flow building unit for an image selected in advance; a display unit that displays execution results of the plurality of image processing flows; a selection unit that receives input information regarding the execution results of the plurality of image processing flows displayed on the display unit; a process flow evaluation unit that calculates an evaluation value of at least one of the plurality of image processing flows on the basis of the input information received by the selection unit; and a storage unit that includes a process flow database in which each of the plurality of image processing flows and the evaluation value are stored so as to match each other.

In addition, according to another aspect of the invention, there is provided an image processing apparatus including: an image processing parameter adjusting unit that presents a plurality of image processing parameter patterns for an image processing flow selected in advance; a process flow execution unit that executes the image processing flow for an image selected in advance using the plurality of image processing parameter patterns; a display unit that displays execution results of the plurality of image processing parameter patterns; a selection unit that receives input information regarding the execution results of the plurality of image processing parameter patterns displayed on the display unit; a parameter evaluation unit that calculates an evaluation value of at least one of the plurality of image processing parameter patterns on the basis of the input information received by the selection unit; and a storage unit that includes a parameter database in which each of the plurality of image processing parameter patterns and the evaluation value are stored so as to match each other.

According to the invention, since a combination of image processing algorithms or image processing parameters can be easily evaluated, it is possible to present an optimal image processing flow according to the intention of the operator by accumulating and learning the evaluation results.

Further features related to the invention will become apparent from the explanation of this specification and the accompanying drawings. In addition, problems, configurations, and effects other than those described above will become apparent from the explanation of the following embodiments.

### BRIEF DESCRIPTION OF THE DRAWINGS

FIG. 1 is a diagram showing the overall configuration of an image processing apparatus according to a first embodiment.

FIG. 2 is a flow chart showing the flow of processing of the image processing apparatus according to the first embodiment.

FIG. 3 is a diagram showing an example of building a process flow in a process flow building unit in the first embodiment.

FIG. 4 is a diagram showing an example of a screen displayed on a display unit of the image processing apparatus.

FIG. 5 is a diagram showing the overall configuration of an image processing apparatus according to a second embodiment.

FIG. 6 is a flow chart showing the flow of processing of the image processing apparatus according to the second embodiment.

FIG. 7 is an example of a process flow selection screen when the operator selects a process flow.

FIG. 8 is a block diagram of an image processing apparatus in which only a processing unit related to label registration processing is shown.

FIG. 9 is a flow chart showing the flow of label registration processing.

FIG. 10 is an example of a label registration screen when registering a label.

FIG. 11 is a diagram showing a score master regarding a process flow including labeling information and a score master regarding an algorithm including labeling information.

FIG. 12 is an example of a screen when searching for a process flow using a label.

FIG. 13 is a diagram showing a score master regarding a hierarchical process flow.

### DESCRIPTION OF EMBODIMENTS

Hereinafter, embodiments of the invention will be described with reference to the accompanying drawings. In addition, the accompanying drawings show specific embodiments based on the principle of the invention, and are for understanding the invention and are not intended to limit the invention.

### Configuration of an Image Processing Apparatus According to a First Embodiment

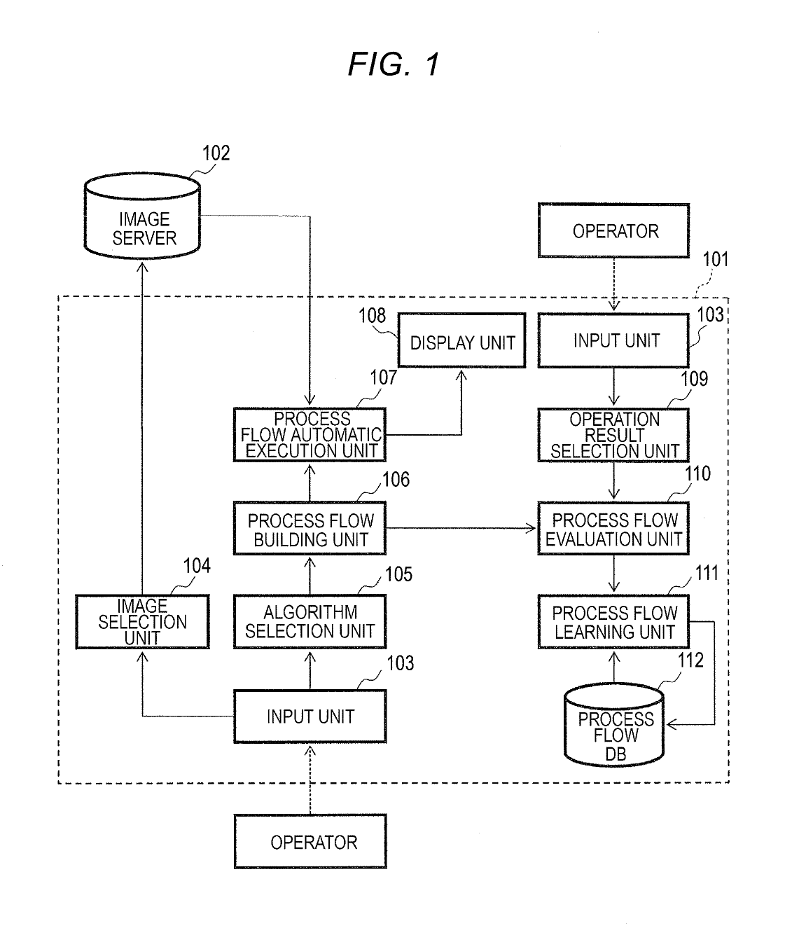

FIG. 1 is a diagram showing the overall configuration of an image processing apparatus according to a first embodiment. An image processing apparatus 101 builds a plurality of image processing flows from the image processing algorithm selected by the operator (user). In addition, the image processing apparatus 101 receives an evaluation of image processing results of the plurality of image processing flows from the operator, calculates the evaluation values of the image processing flows, and registers the combination patterns and the evaluation values of the image processing flows in a database.

In order to perform the above process, the image processing apparatus 101 includes an image server 102, an input unit 103, and a display unit 108 as external interfaces. The image server 102 is a database that stores a desired medical image, for example. The image server 102 is formed by a storage device represented by a hard disk drive (HDD) apparatus. The image processing apparatus 101 acquires a desired image by requesting the image server 102 to acquire the image through a network or the like. For example, in the image server 102, images are stored in a standard “digital imaging and communication in medicine” (DICOM) format commonly used in the field of the image processing apparatus 101. The image processing apparatus 101 can acquire image data using the communication means defined in the standard.

The input unit 103 is a keyboard or a pointing device, such as a mouse. The image processing apparatus 101 receives an input from the operator through the input unit 103. The display unit 108 displays an image processing flow selected by the operator, an image processing result, and the like. A graphical user interface (GUI) is often used as a user interface on the display unit 108, so that the operator can perform interactive input. The display unit 108 is formed by a display using a liquid crystal display or a cathode-ray tube (CRT), for example.

In addition, the image processing apparatus 101 includes an image selection unit 104, an algorithm selection unit 105, a process flow building unit 106, and a process flow automatic execution unit 107. The image selection unit 104 is for selecting an image selected by the operator through the input unit 103. The image selection unit 104 can acquire an image selected by the operator from the image server 102 through the network, for example, using communication means conforming to the DICOM Standard and can display the image on the display unit 108.

In addition, the algorithm selection unit 105 is for selecting an image processing algorithm selected by the operator through the input unit 103. Image processing algorithms for extracting a region in an image include a region glowing method, a level setting method, a graph cutting method, and the like. When the operator selects an image processing algorithm, the image processing apparatus 101 can display image processing algorithms on a GUI on the display unit 108 so that the operator selects an image processing algorithm. The algorithm selection unit 105 inputs the selected image processing algorithm to the process flow building unit 106.

In addition, the process flow building unit 106 automatically generates a plurality of process flows, which can be built, from the image processing algorithm selected by the operator. The method of building a plurality of process flows will be described later. In addition, the process flow building unit 106 inputs the plurality of built process flows to the process flow automatic execution unit 107 and a process flow evaluation unit 110.

In addition, the process flow automatic execution unit 107 applies the plurality of process flows automatically generated by the process flow building unit 106 to the image acquired from the image server 102 (that is, the image selected by the image selection unit 104) and executes the process flows automatically. In addition, the process flow automatic execution unit 107 displays an image processing result (operation result) of each of the plurality of process flows on the display unit 108. The operator can check the plurality of operation results of the process flow automatic execution unit 107 on the display unit 108.

In addition, as a function of evaluating and learning the above operation results, the image processing apparatus 101 includes an operation result selection unit 109, the process flow evaluation unit 110, a process flow learning unit 111, and a process flow database 112.

The operation result selection unit 109 is for receiving an evaluation of the process flow selected by the operator through the input unit 103 or the process flow input by the operator. The operation result selection unit 109 inputs an evaluation of the selected process flow or the input process flow to the process flow evaluation unit 110.

The process flow evaluation unit 110 calculates a score for the process flow on the basis of the information input from the operation result selection unit 109. The process flow evaluation unit 110 inputs the calculated score to the process flow learning unit 111.

The process flow learning unit 111 learns the process flow using the score calculated by the process flow evaluation unit 110. The method of learning the process flow will be described later. The process flow learning unit 111 registers a learning result in the process flow database 112.

### Hardware Configuration of the Image Processing Apparatus

Next, the hardware configuration of the image processing apparatus 101 will be described. The image processing apparatus 101 is formed by an information processing apparatus, such as a workstation or a personal computer. The image processing apparatus 101 includes the input unit 103 and the display unit 108 described above, a memory, a central processing unit, and a storage device. The storage device is a storage medium, such as an HDD, a CD-ROM, or a DVD-ROM.

The central processing unit is formed by a central processing unit (CPU), a microprocessor, or the like. Each processing unit of the image processing apparatus 101 shown in FIG. 1 can also be realized by program codes of the software for realizing a function of each processing unit. That is, each processing unit of the image processing apparatus 101 may be stored in a memory as a program code, and may be realized when the central processing unit executes each program code. In addition, each processing unit of the image processing apparatus 101 may also be realized in hardware by designing it as an integrated circuit, for example.

In addition, the process flow database 112 is stored in a storage device, and the central processing unit performs processing of reading and registering the data of the process flow database 112 using each processing unit of the image processing apparatus 101.

### Configuration of a Database

Next, the configuration of the process flow database 112 in the present embodiment will be described. For example, the process flow database 112 has a table structure. In addition, information in the database of the invention described below does not necessarily need to be expressed in a data structure using a table, and may be expressed in a data structure using a list, a queue, or the like or may be expressed in other data structures. Therefore, in order to indicate that the information in the database of the invention does not depend on the data structure, “table”, “list”, “queue”, and the like may be simply called “information” hereinbelow.

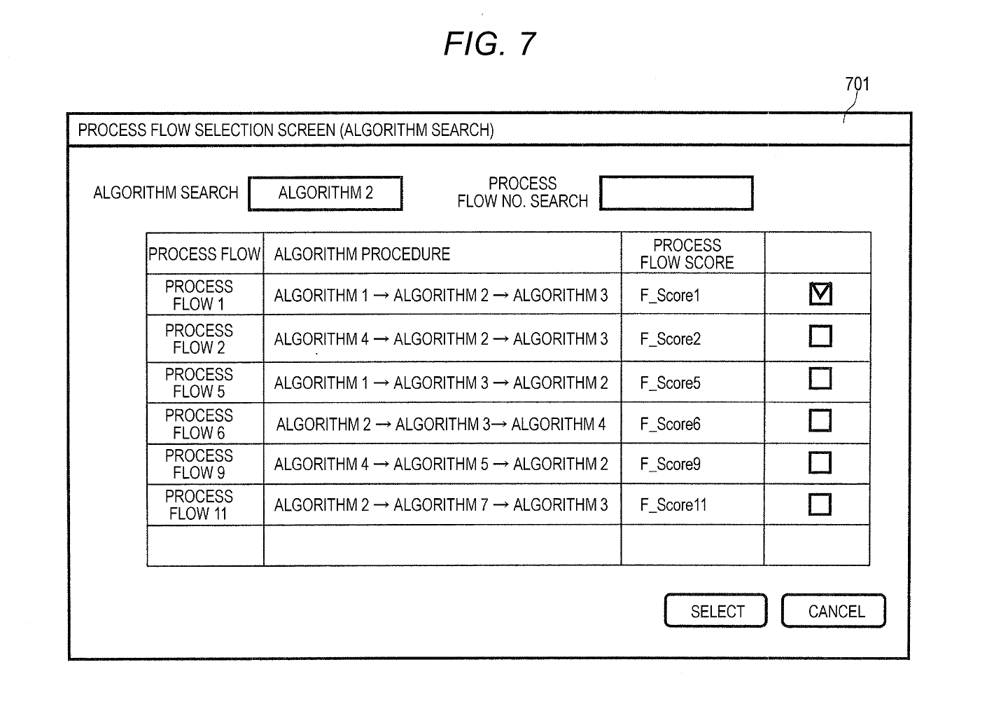

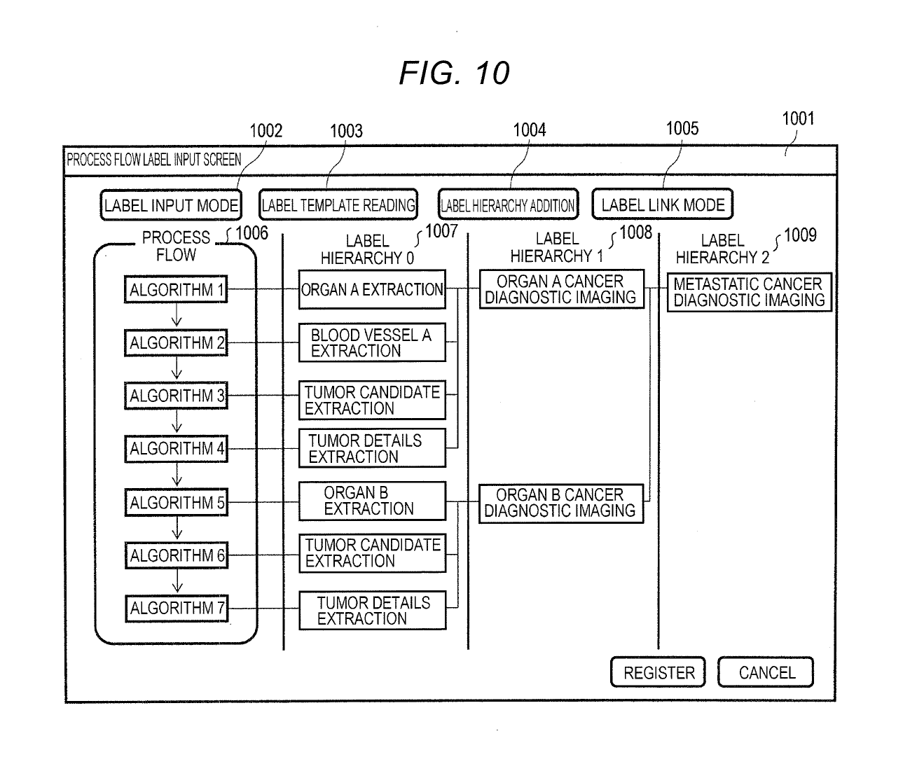

The process flow database 112 stores the information of a plurality of process flows. The process flow database 112 includes, for example, an ID to identify the process flow, a pattern of the process flow, an evaluation value of the process flow, label information given to the process flow, and information regarding the hierarchy of the process flow as configuration items. Here, the information of the pattern of the process flow is information indicating the combination or order of a plurality of image algorithms shown in the “algorithm procedure” of FIG. 7. As shown in FIG. 10, the process flow database 112 may be configured to manage the process flow using a plurality of hierarchies. As information regarding the hierarchy of the process flow, there are information of a hierarchy to which a process flow belongs, information of an identification ID of a process flow of the higher hierarchy than the process flow, and the like, as will be described later. The hierarchy of the process flow may also be expressed by these items of information.

### Processing of the Image Processing Apparatus

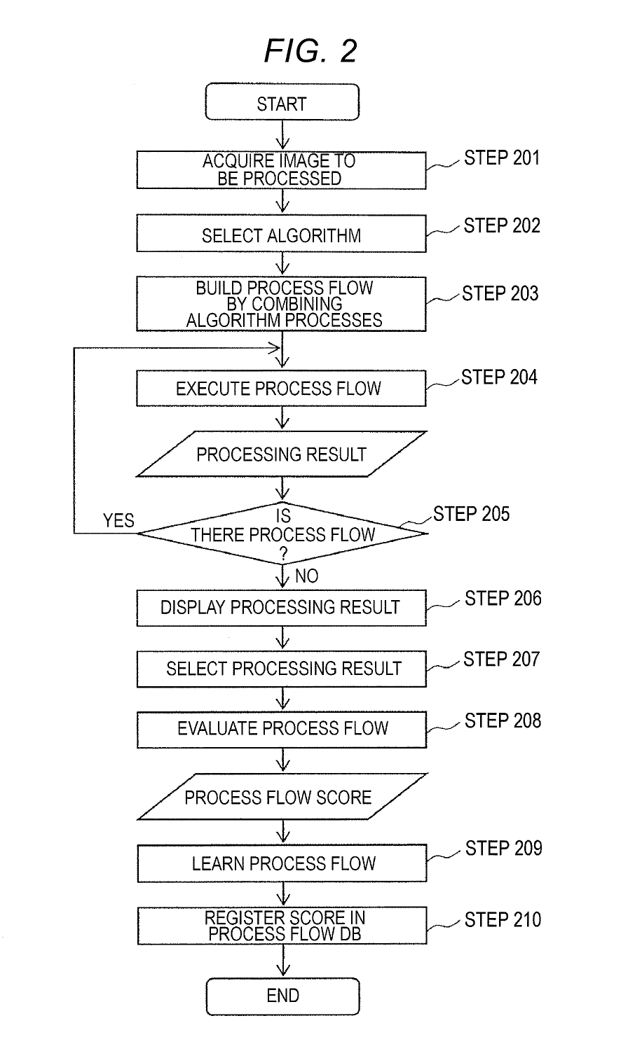

Next, processing performed in the image processing apparatus 101 according to the first embodiment will be described. FIG. 2 is a flow chart showing the flow of the processing of the image processing apparatus 101 according to the first embodiment.

First, in step 201, the image processing apparatus 101 displays a list of images stored in the image server 102 on the display unit 108, and receives an input from the operator. Then, the image selection unit 104 selects an image, which is selected through the input unit 103, as an image to be processed, and the image processing apparatus 101 acquires the selected image from the image server 102.

Then, in step 202, the algorithm selection unit 105 selects an image processing algorithm selected by the operator through the input unit 103. Here, two image processing algorithms to build the process flow are selected from the image processing algorithms set in the image processing apparatus 101. The reason why two algorithms are selected herein is that at least two algorithms are required to build a process flow itself and a process flow cannot be built with a single algorithm.

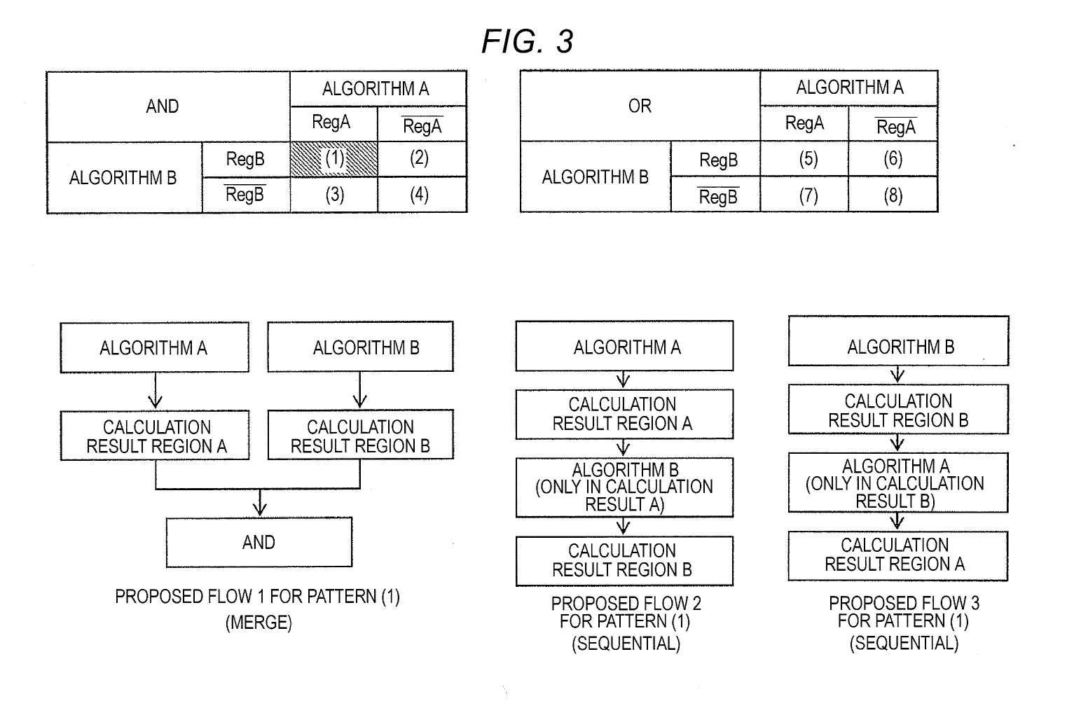

Then, in step 203, the process flow building unit 106 automatically generates a plurality of process flows, which can be built, from the two selected image processing algorithms. An example of building the process flow will be described with reference to FIG. 3. FIG. 3 shows an example of building the process flow when algorithms A and B are selected.

First, extraction regions output by the two selected algorithms A and B are assumed to be RegA and RegB, respectively. As shown in FIG. 3, patterns of the region generated from these extraction regions can be obtained by the logic operation of RegA and RegB, and the patterns are eight patterns (1) to (8) in all. However, when the algorithms A and B are executed as the process flow, only the process flow of eight patterns is not necessarily set. As an example, as shown in FIG. 3, in the case of the pattern (1), that is, in the case of (RegA) AND (RegB), not only the process flow of simply merging the execution results of the respective algorithms but also the flow of calculating RegA and RegB sequentially can be proposed as process flows. As described above, the process flow building unit 106 proposes process flows that can be built.

In addition, the logic operation (AND, OR) of the process flow proposed may be designated by the operator. In addition, in the case of a sequential flow such as a proposed flow 2 or a proposed flow 3 shown in FIG. 3, it is possible to limit a proposed flow pattern by designating the order of algorithms that the operator should execute. In addition, in the example shown in FIG. 3, the process flow based on the AND logic operation of RegA and RegB is proposed. However, depending on the algorithm, it is possible to propose a process flow based on the logic operation of a region that is not RegA and a region that is not RegB. For example, it is possible to propose process flows based on the patterns of (2) to (4) of AND table and the patterns of (6) to (8) of OR table in FIG. 3.

Then, in step 204, the process flow automatic execution unit 107 executes the process flow built in step 203 for the image acquired in step 201. Then, in step 205, the process flow automatic execution unit 107 determines whether or not there is a process flow to be executed. When there is a process flow, the process flow automatic execution unit 107 returns to step 204 to perform the process repeatedly.

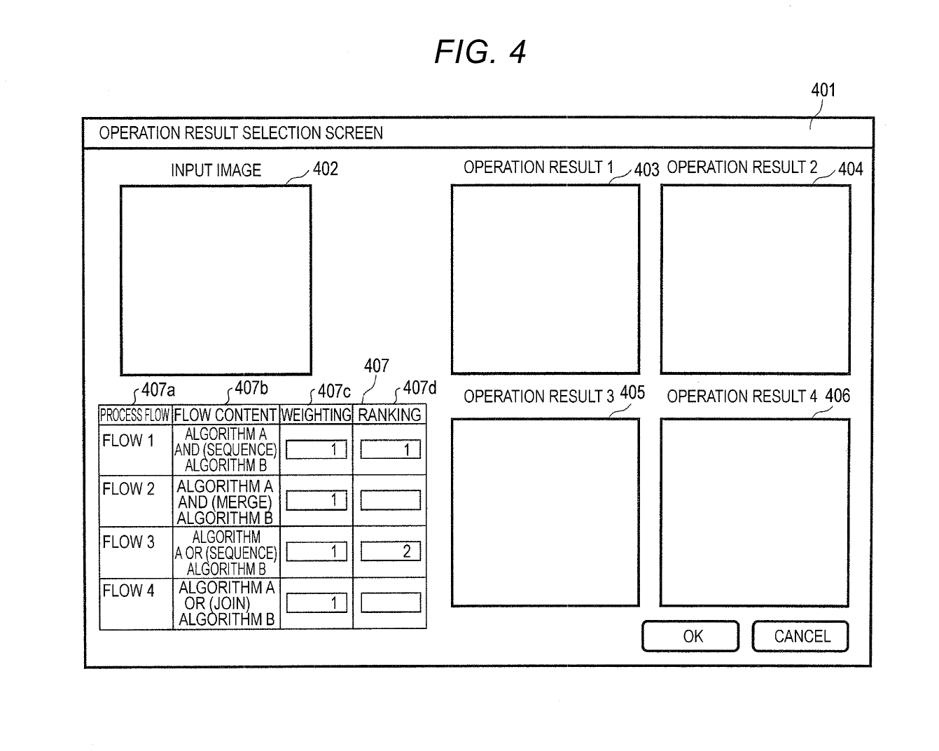

When there is no process flow to be executed, the process flow automatic execution unit 107 displays processing results of all process flows on the display unit 108 in step 206. FIG. 4 shows a specific display example of a processing result.

Then, in step 207, the operation result selection unit 109 receives an evaluation of the process flow selected by the operator through the input unit 103 or the process flow input by the operator. In this case, the operator may not only select a process flow but also rank a plurality of processing results and input the information. In addition, the operator may set the weighting information in order to take into consideration how satisfied the operator is with the selected result. Then, the operation result selection unit 109 inputs an evaluation of the selected process flow or the input process flow to the process flow evaluation unit 110.

Then, in step 208, the process flow evaluation unit 110 calculates a score for the process flow on the basis of the information input from the operation result selection unit 109. When the operator simply selects a processing result, the process flow evaluation unit 110 can evaluate the process flow by calculating the score Flow_Score of the process flow in the following computation expression. Here, w is a weighting factor, and N is the number of selections.

$$Flow\_Score = w \cdot \frac{1}{N} \qquad ( 1 )$$

On the other hand, when the operator ranks and selects a processing result, the process flow evaluation unit 110 can evaluate the process flow by calculating the score Flow_Score of the process flow in the following computation expression. Here, w is a weighting factor, and N is the number of processing results selected by the operator. In addition, “ranking” is the ranking of the process flow set by the operator.

$$Flow\_Score = w \cdot ( \frac{N - ranking}{N - 1} ) \qquad ( 2 )$$

Then, in step 209, the process flow learning unit 111 performs learning of the process flow using the score Flow_Score calculated in step 208. Learning of the process flow is possible by updating the score Flow_Score of the process flow in the following expression. Here, w is a weighting factor, and N is the number of selections.

$${Flow\_Score}_{i + 1} = w \cdot \frac{1}{N} + {Flow\_Score}_{i} \qquad ( 3 )$$

As shown in Expression (3), when there is an evaluation result score Flow_Scoreᵢ executed previously in the same process flow, it is possible to calculate the score Flow_Scoreᵢ₊₁ after learning by adding 1/N as a current evaluation result to the evaluation result score Flow_Scoreᵢ or adding 1/N, for which the weighting input by the user is taken into consideration, to the evaluation result score Flow_Scoreᵢ.

On the other hand, when the operator ranks and selects a processing result, it is possible to update the score Flow_Score of the process flow in the following expression. Here, w is a weighting factor, and N is the number of processing results selected by the operator. In addition, “ranking” is the ranking of the process flow set by the operator.

$${Flow\_Score}_{i + 1} = w \cdot ( \frac{N - ranking}{N - 1} ) + {Flow\_Score}_{i} \qquad ( 4 )$$

As shown in Expression (4), when there is a score Flow_Scoreᵢ as an evaluation result executed previously in the same process flow, it is possible to calculate the score Flow_Scoreᵢ₊ᵢ after learning by adding a value, for which the ranking as a current evaluation result is taken into consideration, to the score Flow_Scoreᵢ or adding a value, for which the weighting and the ranking input by the user are taken into consideration, to the score Flow_Scoreᵢ.

Then, in step 210, the process flow learning unit 111 registers the score Flow_Scoreᵢ₊₁ calculated in step 209 in the process flow database 112. As described above, since the process flow can be more accurately evaluated by taking into consideration the weighting or the ranking input by the operator, the learning effect of the process flow can also be improved. Therefore, it is possible to accumulate the high-accuracy process flow according to the intention of the operator.

In the above-described embodiment, an example of the combination pattern of two algorithms is shown. However, the invention can also be similarly applied to the case of three or more algorithms. For example, it is possible to learn combination patterns of two algorithms first using the above-described method and to learn a pattern based on the combination of one of the two combination patterns having a better learning effect and another algorithm. Thus, as for the process flow of three or more algorithms, it is also possible to present the combination automatically and to learn the process flow by the selection of the operator.

### Screen of the Image Processing Apparatus

FIG. 4 shows an example of a screen displayed on the display unit 108 of the image processing apparatus 101 in step 207. A screen 401 shown in FIG. 4 includes an input image display portion 402, operation result display portions 403, 404, 405, and 406, and a process flow evaluation portion 407.

An image selected by the image selection unit 104 (image acquired from the image server 102) is displayed in the input image display portion 402. In addition, operation results corresponding to the flows 1 to 4 displayed in the process flow evaluation portion 407 are displayed in the operation result display portions 403, 404, 405, and 406.

In the process flow evaluation portion 407, a name 407a to identify the process flow, a specific content 407b of the process flow, a weighting input portion 407c, and a rank input portion 407d are displayed in a table format. The operator can input the numerical value to the weighting input portion 407c and the rank input portion 407d with reference to the operation results displayed in the operation result display portions 403, 404, 405, and 406.

In addition, the numerical value input to the weighting input portion 407c corresponds to the weighting factor w in Expressions (1) to (4). In addition, the numerical value input to the rank input portion 407d corresponds to the ranking of the process flow in Expressions (2) and (4). In addition, in this screen example, the number of numerical values input to the rank input portion 407d can be set as the number N (in FIG. 4, N=2) of processing results selected by the operator.

In addition, when executing Expression (1), only an input portion for inputting which operation result is to be selected may be provided on the screen displayed on the display unit 108.

In this screen example, the operator presses an OK button when the input of evaluation of the process flow ends. When the OK button is pressed, the image processing apparatus 101 performs the process from step 208 in FIG. 2.

According to the present embodiment, in the image processing apparatus that executes an image processing flow based on a single image processing algorithm or an image processing flow based on the combination of a plurality of image processing algorithms, it is possible to accumulate the high-accuracy process flow according to the intention of the operator by evaluating the image processing flow and building the process flow database 112. In addition, according to the present embodiment, when performing image processing using the built process flow database 112, the operator can select the required image processing flow easily. As a result, it is possible to reduce the operation time. In addition, according to the present embodiment, when performing image processing using the built process flow database 112, it is possible to equalize the combination of the process flow that differs depending on the operator in the related art, and it is possible to propose a high-accuracy process flow.

### Configuration of an Image Processing Apparatus According to a Second Embodiment

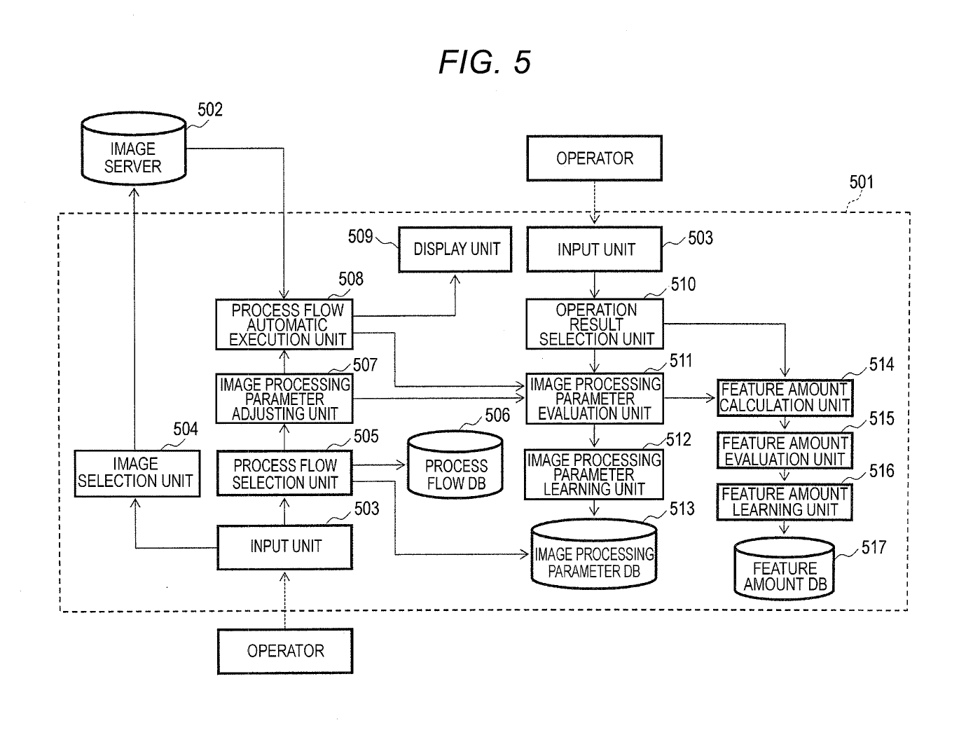

FIG. 5 is a diagram showing the overall configuration of an image processing apparatus according to a second embodiment. An image processing apparatus 501 presents a plurality of image processing parameter patterns for the image processing flow selected by the operator (user). In addition, the image processing apparatus 501 receives an evaluation of image processing results of the plurality of image processing parameter patterns from the operator, calculates the evaluation values of the image processing parameter patterns, and registers the image processing parameter patterns and the evaluation values in an image processing parameter database. In addition, the image processing apparatus 501 learns a feature amount of the extraction region and registers the feature amount in a feature amount database.

The image processing apparatus 501 includes an image server 502, an input unit 503, and a display unit 509 as external interfaces. In addition, since the image server 502, the input unit 503, and the display unit 509 have the same configuration as the image server 102, the input unit 103, and the display unit 108 in the first embodiment, explanation thereof will be omitted.

The image processing apparatus 501 includes a process flow selection unit 505, a process flow database 506, an image processing parameter adjusting unit 507, and a process flow automatic execution unit 508. The process flow selection unit 505 is for selecting a process flow selected by the operator through the input unit 503. Here, a process flow is selected from the process flows stored in the process flow database 506. The process flow selection unit 505 may have a search portion (not shown) to search for a process flow of the process flow database 506. In this case, as shown in FIG. 7, it is possible to search for a process flow using an image processing algorithm as a keyword and select a process flow from the search result. In addition, the process flow selection unit 505 may be made to automatically present some process flows as templates.

The image processing parameter adjusting unit 507 presents a plurality of image processing parameter patterns for the process flow selected by the process flow selection unit 505. The method of setting an image processing parameter automatically will be described later. In addition, for example, when the image processing parameter is one parameter selected from a plurality of items, the image processing parameter adjusting unit 507 can set a plurality of patterns automatically from these items. On the other hand, when the image processing parameter is a numerical value, the image processing parameter adjusting unit 507 may set a plurality of patterns using the lower limit, upper limit, and default value of the numerical value.

In addition, the process flow automatic execution unit 508 applies the plurality of image processing parameter patterns presented by the image processing parameter adjusting unit 507 to the image acquired from the image server 502 (that is, an image selected by an image selection unit 504) and executes the image processing parameter patterns automatically. In addition, the process flow automatic execution unit 508 displays an image processing result (operation result) of each of the plurality of image processing parameter patterns on the display unit 509. The operator can check the plurality of operation results of the process flow automatic execution unit 508 on the display unit 509.

In addition, as a function of evaluating and learning the above operation results, the image processing apparatus 501 includes an operation result selection unit 510, an image processing parameter evaluation unit 511, an image processing parameter learning unit 512, and an image processing parameter database 513.

The operation result selection unit 510 is for receiving an evaluation of the image processing parameter pattern selected by the operator through the input unit 503 or the image processing parameter pattern input by the operator. The operation result selection unit 510 inputs an evaluation of the selected image processing parameter pattern or the input image processing parameter pattern to the image processing parameter evaluation unit 511.

The image processing parameter evaluation unit 511 calculates a score for the image processing parameter pattern on the basis of the information input from the operation result selection unit 510. Then, the image processing parameter evaluation unit 511 inputs the calculated score to the image processing parameter learning unit 512.

The image processing parameter learning unit 512 learns the image processing parameter pattern using the score calculated by the image processing parameter evaluation unit 511. The method of learning the image processing parameter pattern will be described later. The image processing parameter learning unit 512 registers a learning result in the image processing parameter database 513.

In addition, as a function of calculating and evaluating the feature amount of the operation result selected by the operation result selection unit 510, the image processing apparatus 501 includes a feature amount calculation unit 514, a feature amount evaluation unit 515, a feature amount learning unit 516, and a feature amount database 517.

The feature amount calculation unit 514 calculates a feature amount of the extraction region extracted from the operation result selected by the operation result selection unit 510. Here, examples of the feature amount include shape information of an image indicating the volume, surface area, sphericity, mean curvature, Gaussian curvature, and the like of the extraction region, texture information such as Haar-like features, and brightness information or contrast information of an image.

The feature amount evaluation unit 515 calculates a score for the feature amount calculated by the feature amount calculation unit 514. In addition, the feature amount learning unit 516 is for learning the feature amount using the score calculated by the image processing parameter evaluation unit 511. The method of learning the feature amount will be described later.

### Hardware Configuration of the Image Processing Apparatus

Next, the hardware configuration of the image processing apparatus 501 will be described. The image processing apparatus 501 is formed by the same information processing apparatus as the image processing apparatus 101. The image processing apparatus 501 includes the input unit 503 and the display unit 509 described above, a memory, a central processing unit, and a storage device. Accordingly, each processing unit of the image processing apparatus 501 shown in FIG. 5 can also be realized by program codes of the software for realizing a function of each processing unit. That is, each processing unit of the image processing apparatus 501 may be stored in a memory as a program code, and may be realized when the central processing unit executes each program code. In addition, each processing unit of the image processing apparatus 501 may also be realized in hardware by designing it as an integrated circuit, for example.

### Configuration of a Database

Next, the configuration of a database in the present embodiment will be described. In addition, since the process flow database 506 has the same configuration as the process flow database 112 shown in FIG. 1, explanation thereof will be omitted.

The image processing parameter database 513 stores the information of a process flow and image processing parameter patterns used when executing the process flow. The image processing parameter database 513 includes, for example, an ID to identify the process flow, an image processing parameter pattern used when executing the process flow, an evaluation value of the image processing parameter pattern, label information given to the image processing parameter pattern, and information regarding the hierarchy of the process flow as configuration items.

The feature amount database 517 stores the information of a process flow, image processing parameter patterns used when executing the process flow, and the feature amount of the extraction region obtained by executing the process flow. The feature amount database 517 includes, for example, an ID to identify the process flow, an image processing parameter pattern used when executing the process flow, the type of the feature amount of the extraction region obtained by executing the process flow, an evaluation value of the feature amount, and label information given to the feature amount as configuration items.

### Processing of the Image Processing Apparatus

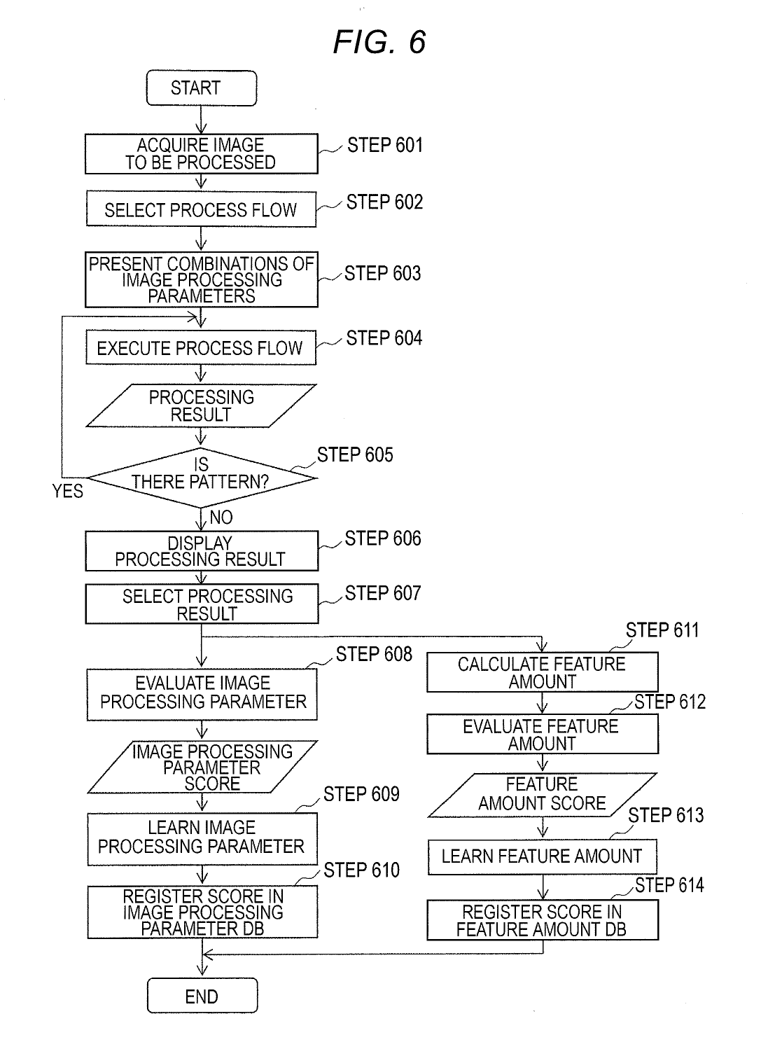

Next, processing performed in the image processing apparatus 501 according to the second embodiment will be described. FIG. 6 is a flow chart showing the flow of the processing of the image processing apparatus 501 according to the second embodiment.

First, in step 601, the image processing apparatus 501 displays a list of images stored in the image server 502 on the display unit 509, and receives an input from the operator. Then, the image selection unit 504 selects an image, which is selected through the input unit 503, as an image to be processed, and the image processing apparatus 501 acquires the selected image from the image server 502.

Then, in step 602, the process flow selection unit 505 selects the process flow selected by the operator through the input unit 503. Here, a process flow is selected from the process flows stored in the process flow database 506. FIG. 7 shows an example of the process flow selection screen. As shown on a screen 701 in FIG. 7, the operator can perform a search of the process flow database 506 using an image processing algorithm as a keyword and select a process flow in which the desired image processing algorithm is included.

Then, in step 603, the image processing parameter adjusting unit 507 presents a plurality of image processing parameter patterns for the process flow selected by the process flow selection unit 505. At the beginning of the operation of the image processing apparatus 501, for example, when the image processing parameter is one parameter selected from a plurality of items, it is possible to set a plurality of patterns automatically from these items. On the other hand, when the image processing parameter is a numerical value, it is possible to set a plurality of patterns using the lower limit, upper limit, and default value of the numerical value. By learning the image processing parameter using the method described below as the operation of the image processing apparatus 501 proceeds, patterns of a plurality of image processing parameters can be presented on the basis of the used parameter distribution using a frequently used item or a frequently used numerical value.

Hereinafter, a method of automatically setting a parameter will be described using Graph Cuts which is an image processing algorithm for region extraction. In the Graph Cuts, a region is extracted by minimizing the energy shown by the following expression and labeling two values for the image.

$$E ( X ) = {\sum }_{v ∈ V}^{ } λ \vert {Y}_{v} - {X}_{v} \vert + \sum \frac{κ}{2} \vert {X}_{u} - {X}_{v} \vert \qquad ( 5 )$$

Here, the first term is called a data term, and the second term is called a smoothing term. In addition, Y is an image, X is a label variable, V is an image set, u and v are pixels, λ is a data term coefficient, and κ is a smoothing term coefficient.

First, an example of selecting one image processing parameter from a plurality of items is shown. An operator desires to extract an organ as a region to be extracted using the Graph Cuts. In the medical image, since there is imaging using a contrast agent, the appearance of the organ on the image varies, for example, when the imaging time is different. Therefore, in the system, a plurality of time phase patterns are prepared in advance, and they can be selected by the user. Selecting this pattern by the operator is equivalent to changing the value of X in Expression (5). By storing the history of the pattern selected by the operator, it is easy to rank a frequently used parameter. Accordingly, it is possible to select a frequently used parameter automatically and present it.

Next, an example when inputting the numerical value of the image processing parameter is shown. In the Graph Cuts, examples of the parameter whose numerical value is input are λ and κ. The default value, minimum value, and maximum value of parameters registered in the system are proposed at the beginning of the operation of the system, but it is possible to obtain the histogram of the value, which is actually used, as the operation proceeds. For example, when the histogram has one peak, it is possible to present the value of the peak and values before and after the peak value by several percent. In addition, in the case of distribution including a plurality of peaks, it is possible to present a plurality of image processing parameters by presenting these values. For the parameters shown this time, a presentation method using a simple majority rule or histogram distribution has been shown. However, it is also possible to learn these parameters by introducing the algorithm for machine learning of the parameters. It is possible to learn the image processing parameter as described above.

Then, in step 604, the process flow automatic execution unit 508 executes the process flow, in which the image processing parameter pattern presented in step 603 is set, for the image acquired in step 601. Then, in step 605, the process flow automatic execution unit 508 determines whether or not there is an image processing parameter pattern to be executed. When there is an image processing parameter pattern, the process flow automatic execution unit 508 returns to step 604 to perform the process repeatedly.

When there is no image processing parameter pattern to be executed, the process flow automatic execution unit 508 displays processing results of all image processing parameter patterns on the display unit 509 in step 606.

Then, in step 607, the operation result selection unit 510 receives an evaluation of the image processing parameter pattern selected by the operator through the input unit 503 or the image processing parameter pattern input by the operator. In this case, the operator may not only select an image processing parameter pattern but also rank a plurality of processing results and input the information. In addition, the operator may set the weighting information in order to take into consideration how satisfied the operator is with the selected result. Then, the operation result selection unit 510 inputs an evaluation of the selected image processing parameter pattern or the input image processing parameter pattern to the image processing parameter evaluation unit 511 and the feature amount calculation unit 514.

After step 607, two flows of steps 608 to 610 and steps 611 to 614 are executed. Hereinafter, steps 608 to 610 will be described first.

In step 608, the image processing parameter evaluation unit 511 calculates a score for the image processing parameter pattern on the basis of the information input from the operation result selection unit 510. When the operator simply selects a processing result, the image processing parameter evaluation unit 511 can evaluate the image processing parameter pattern by calculating the score Parameter_Score of the image processing parameter pattern in the following computation expression. Here, w is a weighting factor, and N is the number of selections.

$$Parameter\_Score = w \cdot \frac{1}{N} \qquad ( 6 )$$

On the other hand, when the operator ranks and selects an image processing parameter pattern, the image processing parameter evaluation unit 511 can evaluate the image processing parameter pattern by calculating the score Parameter_Score of the image processing parameter pattern in the following computation expression. Here, w is a weighting factor, and N is the number of processing results selected by the operator. In addition, “ranking” is the ranking of the image processing parameter pattern set by the operator.

$$Parameter\_Score = w \cdot ( \frac{N - ranking}{N - 1} ) \qquad ( 7 )$$

Then, in step 609, the image processing parameter learning unit 512 performs learning of the image processing parameter pattern using the score Parameter_Score calculated in step 608. Learning of the image processing parameter pattern is possible by updating the score Parameter_Score in the following expression. Here, w is a weighting factor, and N is the number of selections.

$${Parameter\_Score}_{i + 1} = w \cdot \frac{1}{N} + {Parameter\_Score}_{i} \qquad ( 8 )$$

As shown in Expression (8), when there is an evaluation result score Parameter_Scoreᵢ executed previously in the same process flow, it is possible to calculate the score Parameter_Scoreᵢ₊₁ of the image processing parameter pattern by adding 1/N as a current evaluation result to the score Parameter_Scoreᵢ or adding 1/N, for which the weighting input by the user is taken into consideration, to the score Parameter_Scoreᵢ.

On the other hand, when the operator ranks and selects a processing result, it is possible to update the score Parameter_Score in the following expression. Here, w is a weighting factor, and N is the number of processing results selected by the operator. In addition, “ranking” is the ranking of the image processing parameter pattern set by the operator.

$${Parameter\_Score}_{i + 1} = w \cdot ( \frac{N - ranking}{N - 1} ) + {Parameter\_Score}_{i} \qquad ( 9 )$$

As shown in Expression (9), when there is a score Parameter_Scoreᵢ as an evaluation result executed previously in the same process flow, it is possible to calculate the current score Parameter_Scoreᵢ₊ᵢ by adding a value, for which the ranking as a current evaluation result is taken into consideration, to the score Parameter_Scoreᵢ or adding a value, for which the weighting input by the user is taken into consideration, to the score Parameter_Scoreᵢ.

Then, in step 610, the image processing parameter learning unit 512 registers the score Parameter_Scoreᵢ₊₁ calculated in step 609 in the image processing parameter database 513.

Next, steps 611 to 614 will be described.

In step 611, the feature amount calculation unit 514 calculates a feature amount of the extraction region extracted from the operation result selected by the operation result selection unit 510. The feature amount calculated herein may be set in advance, or may be selected from several alternatives by the operator before calculating the feature amount.

Then, in step 612, the feature amount evaluation unit 515 calculates a score for the feature amount of the extraction region, which is extracted from the operation result selected by the operation result selection unit 510, on the basis of the information input from the operation result selection unit 510. When the operator simply selects a processing result, the feature amount evaluation unit 515 can evaluate the feature amount by calculating the score Feature_Score of the feature amount in the following computation expression. Here, w is a weighting factor, and N is the number of selections.

$$Feature\_Score = w \cdot \frac{1}{N} \qquad ( 10 )$$

On the other hand, when the operator ranks and selects an image processing parameter pattern, the feature amount evaluation unit 515 can evaluate the feature amount by calculating the score Feature_Score of the feature amount in the following computation expression. Here, w is a weighting factor, and N is the number of processing results selected by the operator. In addition, “ranking” is the ranking set by the operator.

$$Feature\_Score = w \cdot ( \frac{N - ranking}{N - 1} ) \qquad ( 11 )$$

Then, in step 613, the feature amount learning unit 516 performs learning of the feature amount using the score Feature_Score calculated in step 612. Learning of the feature amount is possible by updating the score Feature_Score in the following expression. Here, w is a weighting factor, and N is the number of selections.

$${Feature\_Score}_{i + 1} = w \cdot \frac{1}{N} + {Feature\_Score}_{i} \qquad ( 12 )$$

As shown in Expression (12), when there is an evaluation result score Feature_Scoreᵢ executed previously in the same process flow, it is possible to calculate the current score Feature_Scoreᵢ₊₁ of the feature amount by adding 1/N as a current evaluation result to the evaluation result score Feature_Scoreᵢ or adding 1/N, for which the weighting input by the user is taken into consideration, to the evaluation result score Feature_Scoreᵢ.

On the other hand, when the operator ranks and selects a processing result, it is possible to update the score Feature_Score in the following expression. Here, w is a weighting factor, and N is the number of processing results selected by the operator. In addition, “ranking” is the ranking set by the operator.

$${Feature\_Score}_{i + 1} = w \cdot ( \frac{N - ranking}{N - 1} ) + {Feature\_Score}_{i} \qquad ( 13 )$$

As shown in Expression (13), when there is a score Feature_Scoreᵢ as an evaluation result executed previously in the same process flow, it is possible to calculate the current score Feature_Scoreᵢ₊₁ by adding a value, for which the ranking as a current evaluation result is taken into consideration, to the score Feature_Scoreᵢ or adding a value, for which the weighting and the ranking input by the user are taken into consideration, to the score Feature_Scoreᵢ.

Then, in step 614, the feature amount learning unit 516 registers the score Feature_Scoreᵢ₊₁ calculated in step 613 in the feature amount database 517. As described above, since the image processing parameter pattern and the feature amount can be more accurately evaluated by taking into consideration the weighting or the ranking input by the operator, the learning effect of the image processing parameter pattern and the feature amount can also be improved. Therefore, it is possible to accumulate the high-accuracy image processing parameter pattern according to the intention of the operator or to accumulate the effective feature amount for each type of lesion.

According to the present embodiment, in the image processing apparatus that executes an image processing flow based on a single image processing algorithm or an image processing flow based on the combination of a plurality of image processing algorithms, it is possible to accumulate the high-accuracy image processing parameter pattern according to the intention of the operator by evaluating the image processing parameter pattern and building the image processing parameter database 513. In addition, according to the present embodiment, when performing image processing using the built image processing parameter database 513, the operator can select an optimal image processing parameter pattern just by selecting the required image processing flow. As a result, it is possible to reduce the operation time.

In addition, according to the present embodiment, in the image processing apparatus that executes an image processing flow based on a single image processing algorithm or an image processing flow based on the combination of a plurality of image processing algorithms, for example, it is possible to accumulate the information of the effective feature amount for each type of lesion by evaluating the feature amount of the extraction region of the processing result selected by the operator and building the feature amount database 517. In particular, in a medical image, depending on the type of lesion, it is not possible to know what kind of feature amount the lesion has. For this reason, it may be difficult to define the feature amount of the lesion. According to the present embodiment, since the evaluation of the feature amount is also performed in parallel with the accumulation of image processing parameter patterns, it is possible to accumulate the information of the effective feature amount for each type of lesion.

### Configuration for Label Registration Processing

Next, label registration processing in the image processing apparatuses 101 and 501 of the first and second embodiments will be described. In the image processing apparatuses 101 and 501 of the first and second embodiments, it is possible to perform labeling processing on the information stored in the process flow database, the image processing parameter database, and the feature amount database. For example, the operator can perform labeling by adding information regarding the medical meaning to each information item with reference to the process flow stored in the process flow database or the image processing parameter stored in the image processing parameter database.

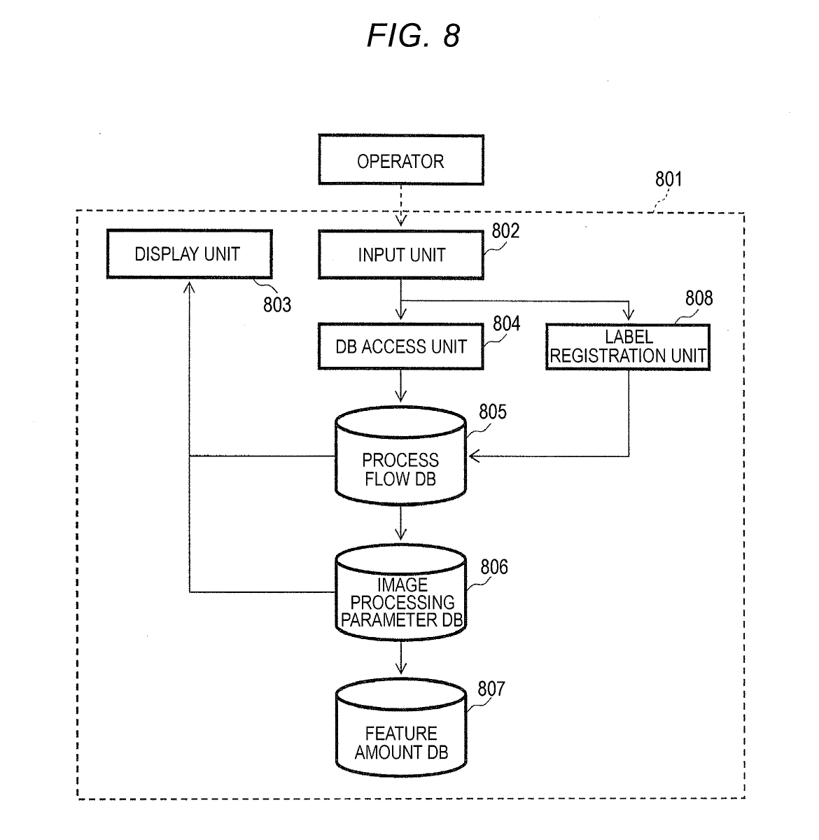

FIG. 8 is a block diagram of an image processing apparatus 801 in which only a processing unit related to the label registration processing is shown. The image processing apparatus 801 includes an input unit 802, a display unit 803, a database access unit 804, and a label registration unit 808. Since the input unit 802 and the display unit 803 have the same configuration as the input unit 103 and the display unit 108 in the first embodiment, explanation thereof will be omitted.

The database access unit 804 is a processing unit used when the operator accesses a database through the input unit 802. In addition, the label registration unit 808 adds a label to the process flow selected by the operator through the input unit 802, and registers the result in a process flow database 805.

In addition, the image processing apparatus 801 includes the process flow database 805, an image processing parameter database 806, and a feature amount database 807. In addition, since the process flow database 805, the image processing parameter database 806, and the feature amount database 807 have the same configuration as the process flow databases 112 and 506, the image processing parameter database 513, and the feature amount database 517 described in the first and second embodiments, explanation thereof will be omitted.

### Label Registration Processing

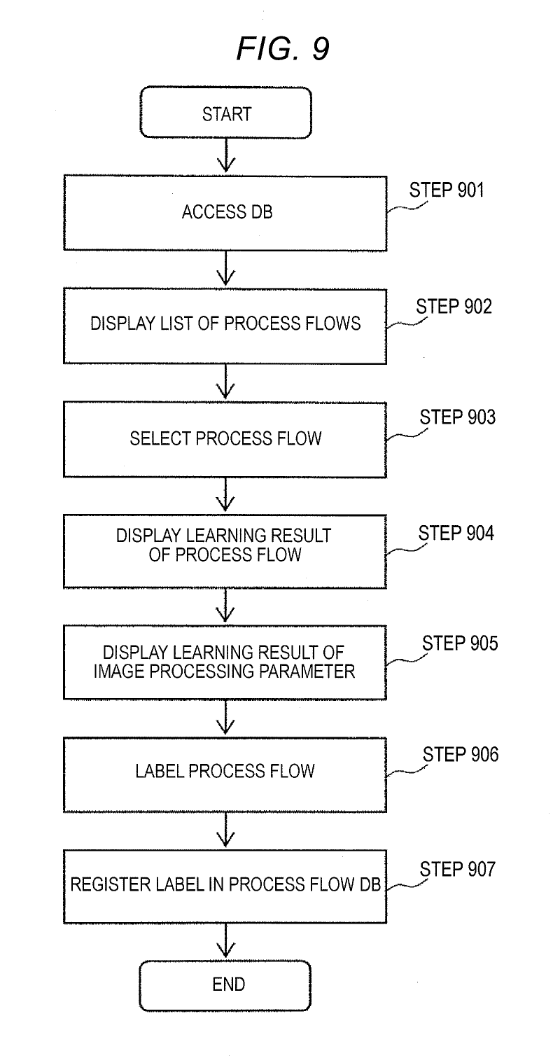

Next, label registration processing performed in the image processing apparatus 801 will be described. FIG. 9 is a flowchart showing the flow of label registration processing.

First, in step 901, the database access unit 804 accesses the process flow database 805. Then, in step 902, the database access unit 804 displays a list of learning results of the process flow registered in the process flow database 805 on the display unit 803.

Then, in step 903, the operator selects a process flow group from the list on the display unit 803 through the input unit 802. Then, in step 904, the operator selects a process flow for performing labeling from the selected process flow group through the input unit 802 with reference to the score Flow_Score of the process flow stored in the process flow database 805.

Then, in step 905, for the selected process flow, the score Parameter_Score of the image processing parameter pattern stored in the image processing parameter database 806 is displayed on the display unit 803. Then, in step 906, the operator inputs a label of the process flow with reference to the score Flow_Score of the process flow and the score Parameter_Score of the image processing parameter pattern. Then, in step 907, the label registration unit 808 adds the label input by the operator to the selected process flow and registers the result in the process flow database 805.

In addition, although the labeling of the process flow in the process flow database 805 has been described, the labeling processing can also be similarly performed in the above-described process flow for the image processing parameter database 806, the feature amount database 807, and the like.

### Labeling Setting Screen

Next, a setting screen for registering a label will be described. FIG. 10 is an example of a label registration screen when registering a label.

A process flow label input screen 1001 includes an input mode button 1002, a template read button 1003, a hierarchy addition button 1004, and a link mode button 1005. In addition, as a display portion, the process flow label input screen 1001 includes a process flow display portion 1006, a first label hierarchy display portion 1007, a second label hierarchy display portion 1008, and a third label hierarchy display portion 1009.

The process flow and the image processing algorithm selected by the operator are displayed in the process flow display portion 1006. The operator selects the process flow and presses the input mode button 1002 or the template read button 1003. When the input mode button 1002 is pressed, for example, a text box is displayed on the process flow label input screen 1001, and the operator can input a label to the text box directly. When the template read button 1003 is pressed, templates (list) of labels are displayed on the process flow label input screen 1001, and the operator can select a label from the templates. In the example shown in FIG. 10, a label “organ A extraction” is input to the “algorithm 1” in the process flow. In this case, the label “organ A extraction” is displayed in the first label hierarchy display portion 1007 as a label hierarchy 0.

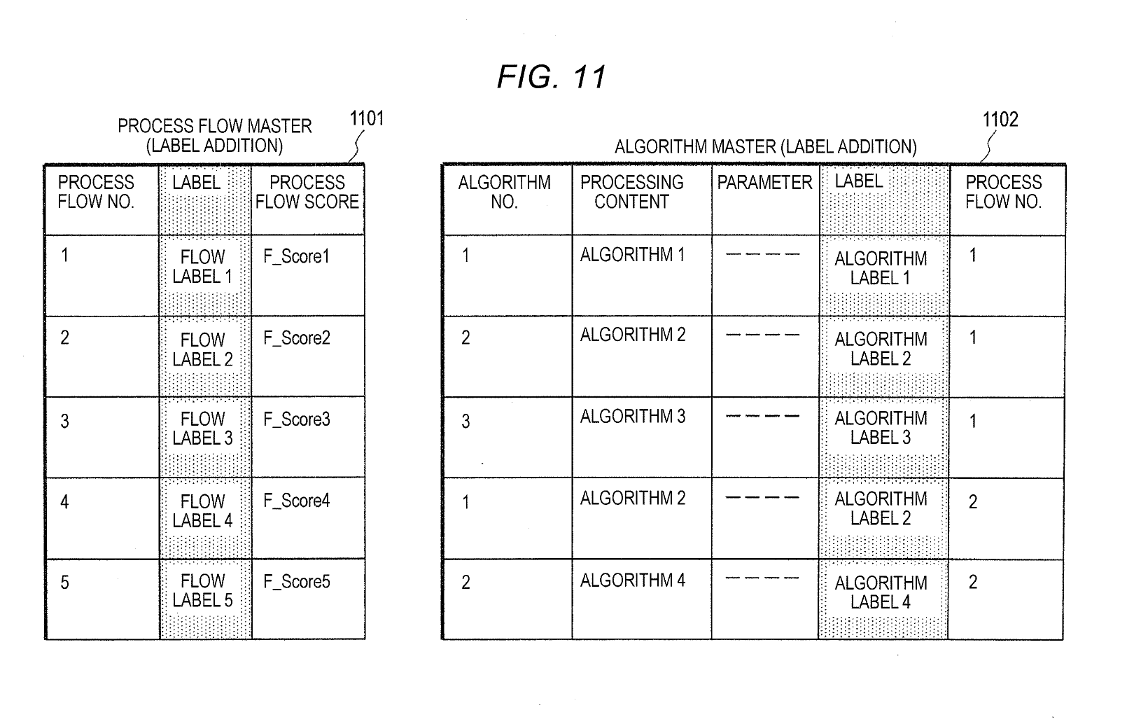

FIG. 11 shows a table when a labeling result is registered in the process flow database 805. For example, the process flow database 805 includes a process flow master table 1101 and an algorithm master table 1102. The process flow master table 1101 includes an item for a label corresponding to the process flow, and a label corresponding to each process flow is input. In addition, the algorithm master table 1102 includes an item for a label corresponding to the algorithm, and a label corresponding to each algorithm is input.

Performing labeling for the image processing algorithm or the process flow and registering the result in a database are advantageous in that it is possible to perform a meaningful search when the operator performs a search of the database. For the operator, the image processing algorithm name does not represent his or her intention to execute the image processing algorithm. Therefore, the operator can select a process flow that matches his or her intention by labeling each algorithm or process flow. In addition, when the operator is a health care worker, a process flow can be stored not as a simple group of image processing algorithms but as a medical process flow.

In addition, labeling can be performed by arbitrarily combining image processing algorithms and process flows, each of which is a group of the image processing algorithms. For example, it is possible to input a label to the second label hierarchy display portion 1008 by pressing the hierarchy addition button 1004. In the example shown in FIG. 10, a label “organ A cancer diagnostic imaging” is input to the second label hierarchy display portion 1008. Here, the operator can link any combination of image processing algorithms to the label “organ A cancer diagnostic imaging” by pressing the link mode button 1005. For example, when the link mode button 1005 is pressed, a line drawing tool is displayed, and the operator can link a plurality of labels of the label hierarchy 0 to the “organ A cancer diagnostic imaging” of the label hierarchy 1 using the line drawing tool. In addition, it is also possible to input a label to the third label hierarchy display portion 1009 by pressing the hierarchy addition button 1004. In the example shown in FIG. 10, the label “organ A cancer diagnostic imaging” and the label “organ B cancer diagnostic imaging” of the label hierarchy 1 are linked to “metastatic cancer diagnostic imaging” of the label hierarchy 2.

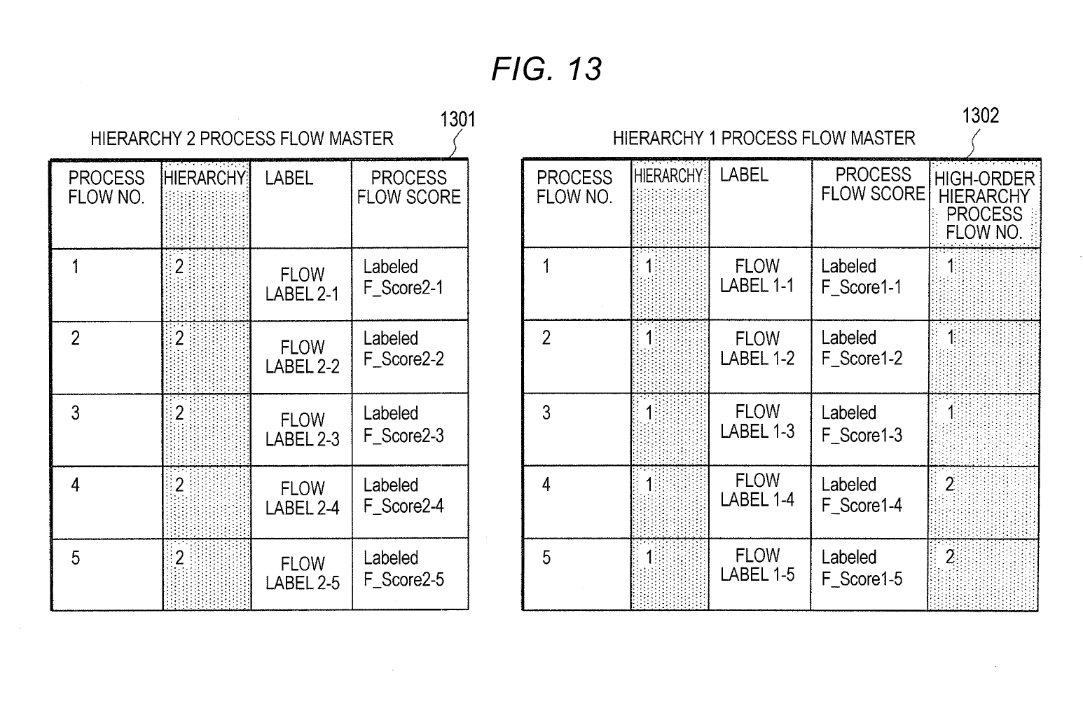

FIG. 13 shows an example of the process flow database 805 when a process flow is defined by a plurality of hierarchies as described above. The process flow database 805 includes a hierarchy 2 process flow master table 1301 and a hierarchy 1 process flow master table 1302. The hierarchy 2 process flow master table 1301 includes an item to input the hierarchy information and an item for a label corresponding to the process flow. In the hierarchy 2 process flow master table 1301, “2” is set in the item of hierarchy information.

In addition, the hierarchy 1 process flow master table 1302 includes an item to input the hierarchy information, an item for a label corresponding to the process flow, and an item to input the information of the high-order hierarchy process flow. In the hierarchy 1 process flow master table 1302, “1” is set in the item of hierarchy information. In addition, the process flow No. of the corresponding hierarchy 2 process flow master table 1301 is input to the item of the information of the high-order hierarchy process flow.

In this case, a score Labeled Flow_Score for the process flow of the high-order hierarchy, which is a group of process flows, can be calculated by the following expression. Here, F_Scoreᵢ is a score of each process flow or each image processing algorithm linked to the process flow of the high-order hierarchy. n is the number of image processing algorithms or process flows linked to the process flow of the high-order hierarchy. In addition, w is a weighting factor. By changing the weighting factor w, it is possible to control the degree of influence of each process flow in the high-order process flow.

$$Labeled Flow\_Score = \frac{{\sum }_{i = 1}^{n} {w}_{i} \cdot {F\_Score}_{i}}{n} , \\ where \\ {\sum }_{i = 1}^{n} {w}_{i} = 1 \qquad ( 14 )$$

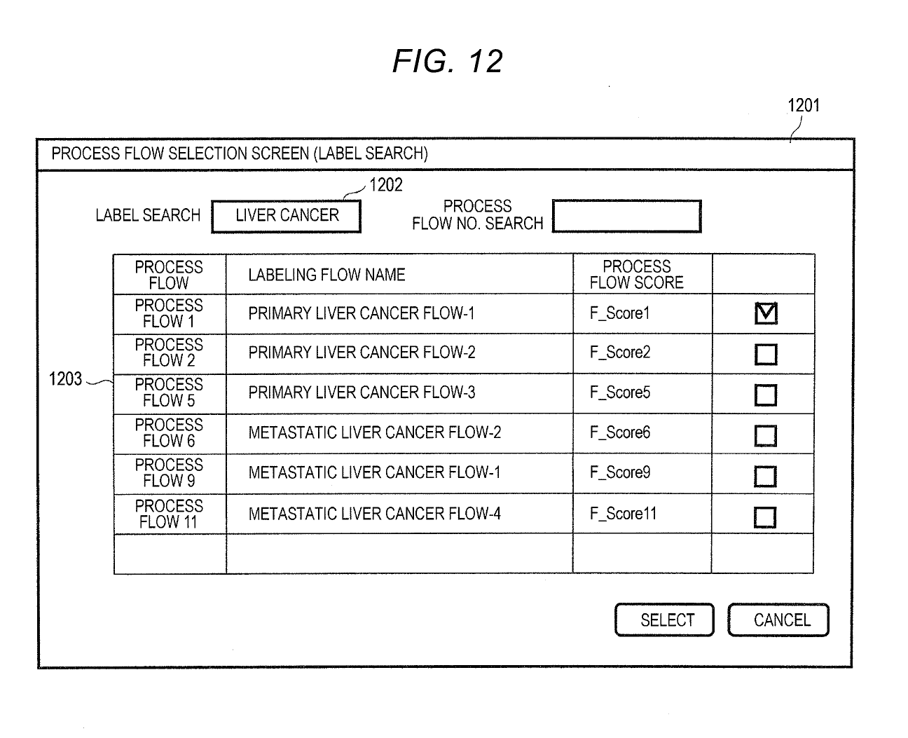

FIG. 12 shows an example of a screen for searching for a process flow from the process flow database 805 in which label information obtained by labeling processing is stored. For example, the process flow selection unit 505 in the second embodiment may have a search portion (not shown) to search for a process flow of the process flow database 805. In this case, as shown in FIG. 12, it is possible to search for a process flow using a keyword and select a process flow from the search result.

In FIG. 12, a character string “liver cancer” is input to the search keyword input portion 1202, and a search of the process flow database 805 is performed. As the search result, process flows including the character string “liver cancer” in labels are displayed in a list in a process flow display portion 1203. In addition, as shown in FIG. 12, scores of the process flows may be displayed together with the list of process flows.

In addition, the label information is not intended to limit the uses of process flows or image processing algorithms. For example, an algorithm labeled as “organ A extraction” may be used for “organ B extraction”.

As described above, according to the present embodiment, it is possible to perform a meaningful search when the operator performs a search of a database by performing labeling for the image processing algorithm or the process flow. As a result, the operator can select a process flow that matches his or her intention.

### Outline

The image processing apparatus 101 according to the first embodiment includes: the process flow building unit 106 that builds a plurality of image processing flows on the basis of a combination of a plurality of image processing algorithms; the process flow automatic execution unit 107 that executes the plurality of image processing flows built by the process flow building unit 106 for an image selected in advance; a display unit 108 that displays execution results of the plurality of image processing flows; an operation result selection unit 109 that receives input information regarding the execution results of the plurality of image processing flows displayed on the display unit 108; a process flow evaluation unit 110 that calculates an evaluation value of at least one of the plurality of image processing flows on the basis of the input information received by the operation result selection unit 109; and a storage device that includes a process flow database 112 in which each of the plurality of image processing flows and the evaluation value are stored so as to match each other.

According to this configuration, in the image processing apparatus that executes an image processing flow based on a single image processing algorithm or the combination of a plurality of image processing algorithms, it is possible to accumulate the high-accuracy process flow according to the intention of the operator by evaluating the image processing flow and building the process flow database 112. In addition, when performing image processing using the built process flow database 112, the operator can easily select the required image processing flow by referring to the evaluation value. As a result, it is possible to reduce the operation time. In addition, when performing image processing using the built process flow database 112, it is possible to equalize the combination of process flows that differs depending on the operator in the related art, and it is possible to propose a high-accuracy process flow. In addition, the present embodiment can be applied to image processing in various fields if the purpose is to accumulate the more effective process flows by combining a plurality of algorithms. In particular, it is beneficial to apply the present embodiment to image processing of a medical image in order to accumulate the more effective process flows for extracting a region, such as lesion.

In addition, the image processing apparatus 501 according to the second embodiment includes: the image processing parameter adjusting unit 507 that presents a plurality of image processing parameter patterns for an image processing flow selected in advance; the process flow automatic execution unit 508 that executes the image processing flow for an image selected in advance using the plurality of image processing parameter patterns; the display unit 509 that displays execution results of the plurality of image processing parameter patterns; the operation result selection unit 510 that receives input information regarding the execution results of the plurality of image processing parameter patterns displayed on the display unit 509; the image processing parameter evaluation unit 511 that calculates an evaluation value of at least one of the plurality of image processing parameter patterns on the basis of the input information received by the operation result selection unit 510; and a storage device that includes the image processing parameter database 513 in which each of the plurality of image processing parameter patterns and the evaluation value are stored so as to match each other.

According to this configuration, in the image processing apparatus that executes an image processing flow based on a single image processing algorithm or the combination of a plurality of image processing algorithms, it is possible to accumulate the high-accuracy image processing parameter pattern according to the intention of the operator by evaluating the image processing parameter pattern and building the image processing parameter database 513. In addition, when performing image processing using the built image processing parameter database 513, the operator can set an optimal image processing parameter pattern just by selecting the required image processing flow. As a result, it is possible to reduce the operation time. In addition, the present embodiment can be applied to image processing in various fields if the purpose is to accumulate the more effective image processing parameter patterns. In particular, it is beneficial to apply the present embodiment to image processing of a medical image in order to accumulate parameter patterns for the image processing for extracting a region, such as lesion.

In addition, the image processing apparatus 501 according to the second embodiment further includes: the feature amount calculation unit 514 that calculates a feature amount of an extraction region extracted by the plurality of image processing parameter patterns; and the feature amount evaluation unit 515 that calculates an evaluation value of the feature amount on the basis of the input information received by the operation result selection unit 510. The storage device further includes the feature amount database 517 in which the feature amount and the evaluation value of the feature amount are stored so as to match each other.

According to this configuration, in the image processing apparatus that executes an image processing flow based on a single image processing algorithm or the combination of a plurality of image processing algorithms, for example, it is possible to accumulate the information of the effective feature amount for each type of lesion by evaluating the feature amount of the extraction region of the processing result selected by the operator and building the feature amount database 517. Therefore, since the evaluation of the feature amount is also performed in parallel with the accumulation of image processing parameter patterns, it is possible to accumulate the information of the effective feature amount for each type of lesion.

In addition, the invention is not limited to the embodiments described above, and various modifications are included. For example, the above embodiments have been described in detail in order to describe the invention easily, and all components described do not necessarily need to be provided. In addition, a part of the configuration of one embodiment may be replaced with the configuration of another embodiment, and the configuration of another embodiment may be added to the configuration of one embodiment. In addition, for a part of the configuration of each embodiment, addition, removal, and replacement of other configurations are possible.

In the first and second embodiments described above, the process flow learning unit 111, the image processing parameter learning unit 512, and the feature amount learning unit 516 are provided. However, this configuration is a more preferable form of the invention. In terms of accumulating the evaluated process flow or image processing parameter pattern, it is possible to configure the invention by removing some or all of the learning units 111, 512, and 516. In this case, scores calculated by the process flow evaluation unit 110, the image processing parameter evaluation unit 511, and the feature amount evaluation unit 515 are stored in a database as they are.

The image processing apparatus 501 according to the second embodiment of the above-described embodiments includes the feature amount calculation unit 514, the feature amount evaluation unit 515, and the feature amount learning unit 516. However, the invention is not limited to this configuration. For example, the feature amount calculation unit 514, the feature amount evaluation unit 515, and the feature amount learning unit 516 may also be included in the image processing apparatus 101 according to the first embodiment. In this case, it is possible to perform calculation, evaluation, and learning of the feature amount for the process flow selected by the operation result selection unit 109.

In the first and second embodiments described above, the process flow database 112 shown in FIG. 1, the process flow database 506, the image processing parameter database 513, and the feature amount database 517 shown in FIG. 5, and the process flow database 805, the image processing parameter database 806, and the feature amount database 807 shown in FIG. 8 are provided in the system. However, the invention is not limited to this configuration. For example, each database may be provided outside a system, in particular, as a cloud server outside the hospital where the system is installed, and results obtained by accumulating, evaluating, and learning process flows, image processing parameters, and feature amounts in the hospital where the system is installed using the above-described method may be stored in the cloud server through a network. In addition, since a plurality of hospitals where this system is installed can store the result in each hospital in the cloud server outside the hospitals, it is possible to share the information among different hospitals.

In addition, in the first and second embodiments described above, the image processing apparatus 101 shown in FIG. 1, the image processing apparatus 501 shown in FIG. 5, and the image processing apparatus 801 shown in FIG. 8 are not limited to being installed in a hospital. For example, all components excluding the input unit and the display unit of the image processing apparatus may be provided as a cloud system outside a hospital, and connections to the cloud system may be made through a network to accumulate, evaluate, and learn process flows, image processing parameters, and feature amounts using the above-described method. In addition, it is possible to share the information among a plurality of hospitals.

As described above, the image processing apparatuses 101 and 501 may be realized by program codes of the software for realizing each function of the embodiment. In this case, a storage medium on which the program codes are recorded is provided for the information processing apparatus, and the information processing apparatus (or the CPU) reads the program codes stored in the storage medium. In this case, the program codes themselves read from the storage medium realize the function of each embodiment described above, and these program codes themselves and the storage medium in which the program codes are stored constitute the invention. As examples of storage media for supplying such program codes, a flexible disk, a CD-ROM, a DVD-ROM, a hard disk, an optical disc, a magneto-optical disc, a CD-R, a magnetic tape, a nonvolatile memory card, and a ROM are used.

In addition, an OS (operating system) running on the information processing apparatus or the like may perform a part or all of the actual processing in response to the instruction of program codes, and the function of each embodiment described above may be realized by the processing. In addition, program codes of the software for realizing the function of each embodiment may be transmitted through a network and be stored in a storage device of the information processing apparatus or a storage medium, such as a CD-RW or a CD-R, and the CPU of the information processing apparatus may read and execute the program codes stored in the storage device or the storage medium when the program codes need to be used.

Although the invention has been described by way of specific examples, these are not for limitation but for illustration in all points of view. Those skilled in the art will understand that there are multiple combinations of appropriate hardware, software, and firmware to implement the invention. For example, program codes for realizing the functions described in the present embodiment can be realized in a wide range of programs or script languages, such as assembler, C/C++, perl, Shell, PHP, and Java (registered trademark).

In addition, the image processing apparatuses 101 and 501 may also be realized in hardware by designing a part or all of the apparatus as an integrated circuit, for example.

In addition, control lines or information lines in the drawings indicate what is considered to be required for explanation, and all control lines or all information lines on products are not necessarily shown. All configurations may be connected to each other.

The invention is useful as a technique for selecting the optimal image processing and performing image processing efficiently particularly when performing image processing on an image multiple times to extract a desired region in an image processing apparatus.

What is claimed is:

1. An image processing apparatus comprising:
a process flow building unit that builds a plurality of image processing flows on the basis of a combination of a plurality of image processing algorithms;
a process flow execution unit that executes the plurality of image processing flows built by the process flow building unit for an image selected in advance;
a display unit that displays execution results of the plurality of image processing flows;
a selection unit that receives input information regarding the execution results of the plurality of image processing flows displayed on the display unit;
a process flow evaluation unit that calculates an evaluation value of at least one of the plurality of image processing flows on the basis of the input information received by the selection unit; and
a storage unit that includes a process flow database in which each of the plurality of image processing flows and the evaluation value are stored so as to match each other.

2. The image processing apparatus according to claim 1,
wherein the input information is first input information including the number of image processing flows selected by an operator and a weighting factor or second input information including the number of image processing flows selected by the operator, a weighting factor, and ranking information of the plurality of image processing flows, and
the process flow evaluation unit calculates the evaluation value on the basis of the first input information or the second input information.

3. The image processing apparatus according to claim 1, further comprising:
a process flow learning unit that calculates an evaluation value of at least one of the plurality of image processing flows using previous evaluation values stored in the process flow database.

4. The image processing apparatus according to claim 3,
wherein the input information is first input information including the number of image processing flows selected by an operator and a weighting factor or second input information including the number of image processing flows selected by the operator, a weighting factor, and ranking information of the plurality of image processing flows, and
the process flow learning unit calculates the evaluation value on the basis of the first input information or the second input information and previous evaluation values stored in the process flow database.

5. The image processing apparatus according to claim 1,
wherein the image is a medical image.

6. An image processing apparatus comprising:
an image processing parameter adjusting unit that presents a plurality of image processing parameter patterns for an image processing flow selected in advance;
a process flow execution unit that executes the image processing flow for an image selected in advance using the plurality of image processing parameter patterns;
a display unit that displays execution results of the plurality of image processing parameter patterns;
a selection unit that receives input information regarding the execution results of the plurality of image processing parameter patterns displayed on the display unit;
a parameter evaluation unit that calculates an evaluation value of at least one of the plurality of image processing parameter patterns on the basis of the input information received by the selection unit; and
a storage unit that includes a parameter database in which each of the plurality of image processing parameter patterns and the evaluation value are stored so as to match each other.

7. The image processing apparatus according to claim 6,
wherein the input information is first input information including the number of image processing parameter patterns selected by an operator and a weighting factor or second input information including the number of image processing parameter patterns selected by the operator, a weighting factor, and ranking information of the plurality of image processing parameter patterns, and
the parameter evaluation unit calculates the evaluation value on the basis of the first input information or the second input information.

8. The image processing apparatus according to claim 6, further comprising:
a parameter learning unit that calculates an evaluation value of at least one of the plurality of image processing parameter patterns using previous evaluation values stored in the parameter database.

9. The image processing apparatus according to claim 8,
wherein the input information is first input information including the number of image processing parameter patterns selected by an operator and a weighting factor or second input information including the number of image processing parameter patterns selected by the operator, a weighting factor, and ranking information of the plurality of image processing parameter patterns, and
the parameter learning unit calculates the evaluation value on the basis of the first input information or the second input information and previous evaluation values stored in the parameter database.

10. The image processing apparatus according to claim 6, further comprising:
a feature amount calculation unit that calculates a feature amount of an extraction region extracted by the plurality of image processing parameter patterns; and
a feature amount evaluation unit that calculates an evaluation value of the feature amount on the basis of the input information received by the selection unit,
wherein the storage unit further includes a feature amount database in which the feature amount and the evaluation value of the feature amount are stored so as to match each other.

11. The image processing apparatus according to claim 10, further comprising:
a feature amount learning unit that calculates an evaluation value of the feature amount using previous evaluation values of the feature amount stored in the feature amount database.

12. The image processing apparatus according to claim 6,
wherein the storage unit further includes a process flow database in which a plurality of image processing flows are stored, and
a process flow selection unit that selects an image processing flow, as the image processing flow selected in advance, from the plurality of image processing flows stored in the process flow database is further provided.

13. The image processing apparatus according to claim 12, further comprising:
a label registration unit that registers a label for each image processing flow stored in the process flow database,
wherein the process flow selection unit includes a search unit that searches for the plurality of image processing flows stored in the process flow database using the label.

14. The image processing apparatus according to claim 6,
wherein the image is a medical image.
